(19) United States
(12) Patent Application Publication
(10) Pub. No.: US 2026/0301345 A1
(43) Pub. Date: Oct. 1, 2026

(54) REMODEL VISUALIZATION

(71) Applicant: Apple Inc., Cupertino, CA (US)

(72) Inventors: Vincent P. Sparacino, San Bruno, CA (US); Pravalika Avvaru, San Jose, CA (US); Ronald V. Siy, San Francisco, CA (US); Tyler C. Dahl, San Jose, CA (US); Mohammadreza Armandpour, Mountain View, CA (US)

(21) Appl. No.: 19/572,049

(22) Filed: Mar. 19, 2026

Related U.S. Application Data
(60) Provisional application No. 63/777,998, filed on Mar. 26, 2025.

(51) Int. Cl. G06T 19/20; G06T 19/00

(52) U.S. Cl. CPC G06T 19/20; G06T 19/006; G06T 2219/2004

(57) ABSTRACT

In one implementation, a method of displaying a virtual environment is performed by a device in a physical environment and including a display, one or more processors, and non-transitory memory. The method includes obtaining a three-dimensional (3D) model of the physical environment. The method includes obtaining a 3D model of a virtual environment. The method includes determining an alignment score of a transform of the 3D model of the virtual environment. The method includes, in response to determining that the alignment score is greater than a threshold score, applying the transform to the 3D model of the virtual environment and displaying a portion of the virtual environment based on the transformed 3D model of the virtual environment.

### CROSS-REFERENCE TO RELATED APPLICATIONS

This application claims priority to U.S. Provisional Patent App. No. 63/777,998, filed on Mar. 26, 2025, which is hereby incorporated by reference in its entirety.

### TECHNICAL FIELD

The present disclosure generally relates to systems, methods, and devices of displaying an altered model of a physical environment in conjunction with the physical environment.

### BACKGROUND

To demonstrate recommended changes, an interior designer can generate a three-dimensional model of a remodel or renovation of a physical environment and display that model to a potential client.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIG. 1 is a block diagram of an example operating environment in accordance with some implementations.

FIGS. 2A-2I illustrate a plurality of images captured by an image sensor of an electronic device and a plurality of images displayed by a display of the electronic device during an extended reality experience in accordance with some implementations.

FIGS. 3A-3G illustrate a plurality of images captured by an image sensor of an electronic device and a plurality of images displayed by a display of the electronic device during a virtual reality experience in accordance with some implementations.

FIG. 4 is a flowchart representation of a method of displaying a virtual environment in accordance with some implementations.

FIG. 5 is a block diagram of an example controller in accordance with some implementations.

FIG. 6 is a block diagram of an example electronic device in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### SUMMARY

Various implementations disclosed herein include devices, systems, and methods for displaying a virtual environment. In various implementations, the method is performed by a device in a physical environment and including a display, one or more processors, and non-transitory memory. The method includes obtaining a three-dimensional (3D) model of the physical environment. The method includes obtaining a 3D model of a virtual environment. The method includes determining an alignment score of a transform of the 3D model of the virtual environment. The method includes, in response to determining that the alignment score is greater than a threshold score, applying the transform to the 3D model of the virtual environment and displaying a portion of the virtual environment based on the transformed 3D model of the virtual environment.

In accordance with some implementations, a device includes one or more processors, a non-transitory memory, and one or more programs; the one or more programs are stored in the non-transitory memory and configured to be executed by the one or more processors and the one or more programs include instructions for performing or causing performance of any of the methods described herein. In accordance with some implementations, a non-transitory computer readable storage medium has stored therein instructions, which, when executed by one or more processors of a device, cause the device to perform or cause performance of any of the methods described herein. In accordance with some implementations, a device includes: one or more processors, a non-transitory memory, and means for performing or causing performance of any of the methods described herein.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices and circuits have not been described in exhaustive detail so as not to obscure more pertinent aspects of the example implementations described herein.

As suggested above, to demonstrate recommended changes to a physical environment, such as room or a home, an interior designer can generate a three-dimensional (3D) model of a remodel or renovation of the physical environment and display that model to a potential client. However, it can be difficult to imagine how the proposed changes correspond to the physical environment. Accordingly, in various implementations, the 3D model can be displayed in conjunction with and aligned with the physical environment as an augmented reality (AR) experience.

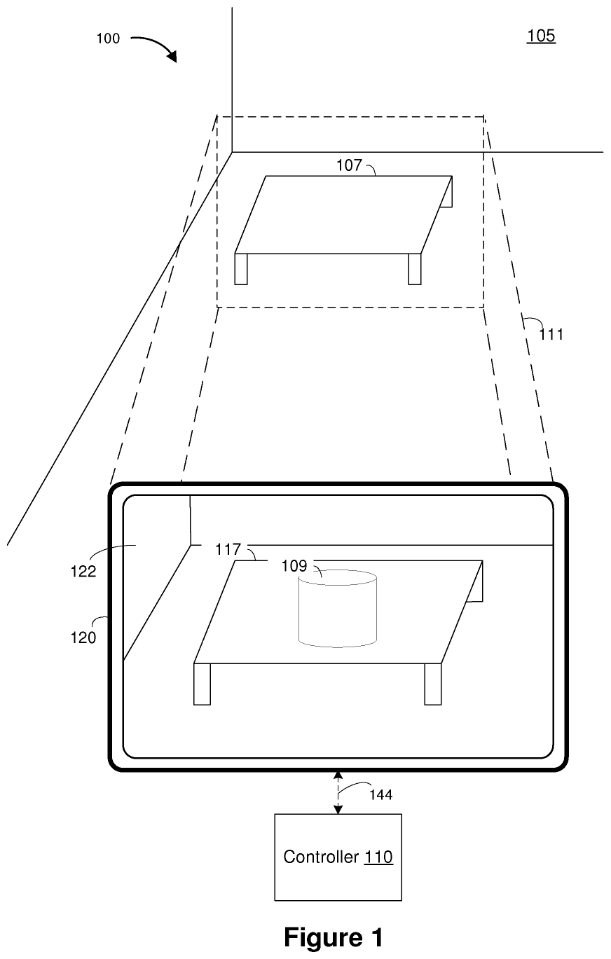

FIG. 1 is a block diagram of an example operating environment 100 in accordance with some implementations. While pertinent features are shown, those of ordinary skill in the art will appreciate from the present disclosure that various other features have not been illustrated for the sake of brevity and so as not to obscure more pertinent aspects of the example implementations disclosed herein. To that end, as a non-limiting example, the operating environment 100 includes a controller 110 and an electronic device 120.

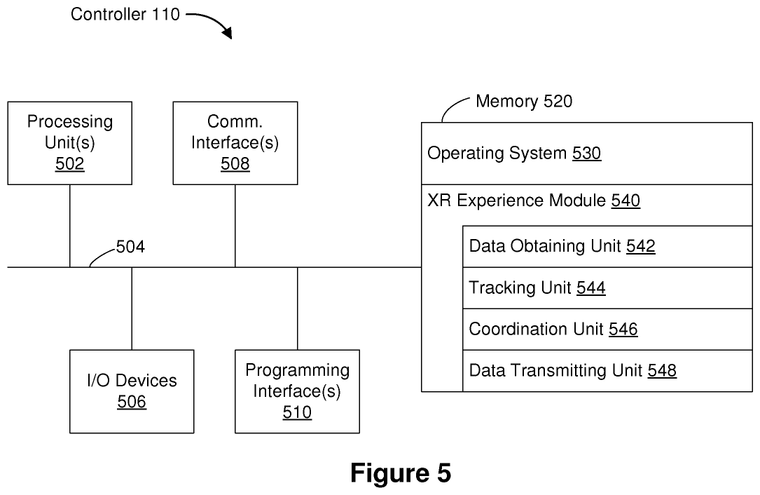

In some implementations, the controller 110 is configured to manage and coordinate an XR experience for the user. In some implementations, the controller 110 includes a suitable combination of software, firmware, and/or hardware. The controller 110 is described in greater detail below with respect to FIG. 5. In some implementations, the controller 110 is a computing device that is local or remote relative to the physical environment 105. For example, the controller 110 is a local server located within the physical environment 105. In another example, the controller 110 is a remote server located outside of the physical environment 105 (e.g., a cloud server, central server, etc.). In some implementations, the controller 110 is communicatively coupled with the electronic device 120 via one or more wired or wireless communication channels 144 (e.g., BLUETOOTH, IEEE 802.11x, IEEE 802.16x, IEEE 802.3x, etc.). In another example, the controller 110 is included within the enclosure of the electronic device 120. In some implementations, the functionalities of the controller 110 are provided by and/or combined with the electronic device 120.

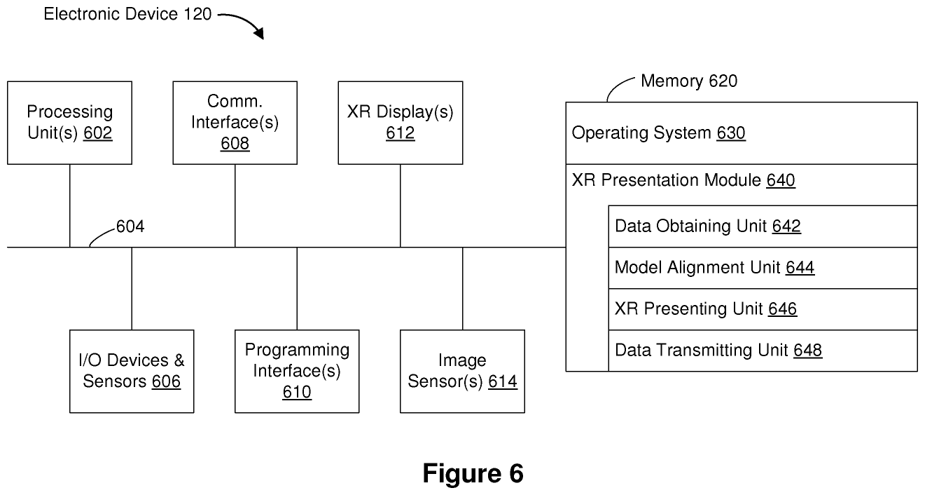

In some implementations, the electronic device 120 is configured to provide the XR experience to the user. In some implementations, the electronic device 120 includes a suitable combination of software, firmware, and/or hardware. According to some implementations, the electronic device 120 presents, via a display 122, XR content to the user while the user is virtually or physically present within the physical environment 105 that includes a table 107 within the field-of-view 111 of the electronic device 120. As such, in some implementations, the user holds the electronic device 120 in his/her hand(s). In some implementations, while providing XR content, the electronic device 120 is configured to display an XR object (e.g., an XR cylinder 109) and to enable video pass-through of the physical environment 105 (e.g., including a representation 117 of the table 107) on a display 122. The electronic device 120 is described in greater detail below with respect to FIG. 6.

In some implementations, the user wears the electronic device 120 on his/her head. For example, in some implementations, the electronic device includes a head-mounted system (HMS), head-mounted device (HMD), or head-mounted enclosure (HME). As such, the electronic device 120 includes one or more XR displays provided to display the XR content. For example, in various implementations, the electronic device 120 encloses the field-of-view of the user. In some implementations, the electronic device 120 is a handheld device (such as a smartphone or tablet) configured to present XR content, and rather than wearing the electronic device 120, the user holds the device with a display directed towards the field-of-view of the user and a camera directed towards the physical environment 105. In some implementations, the handheld device can be placed within an enclosure that can be worn on the head of the user. In some implementations, the electronic device 120 is replaced with an XR chamber, enclosure, or room configured to present XR content in which the user does not wear or hold the electronic device 120.

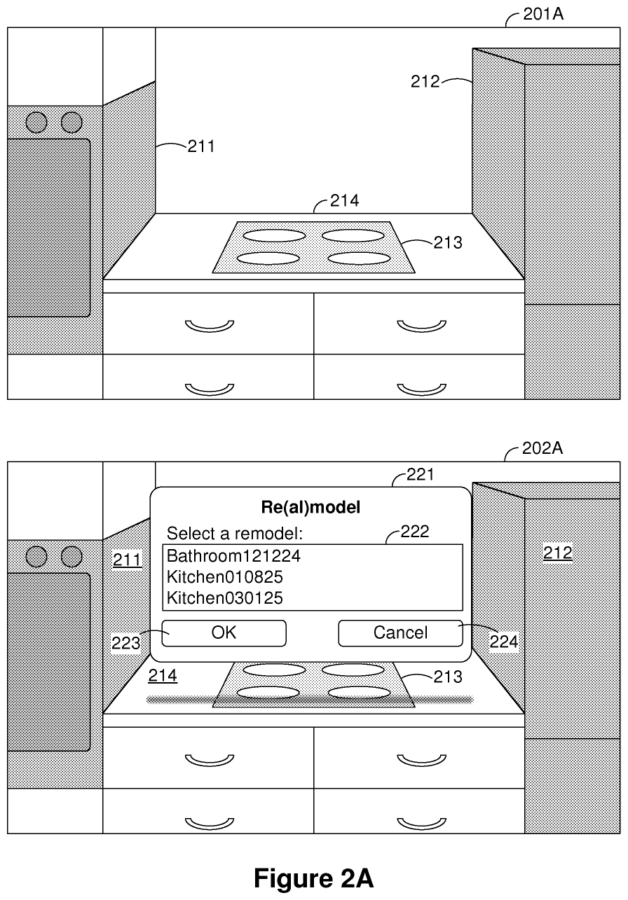

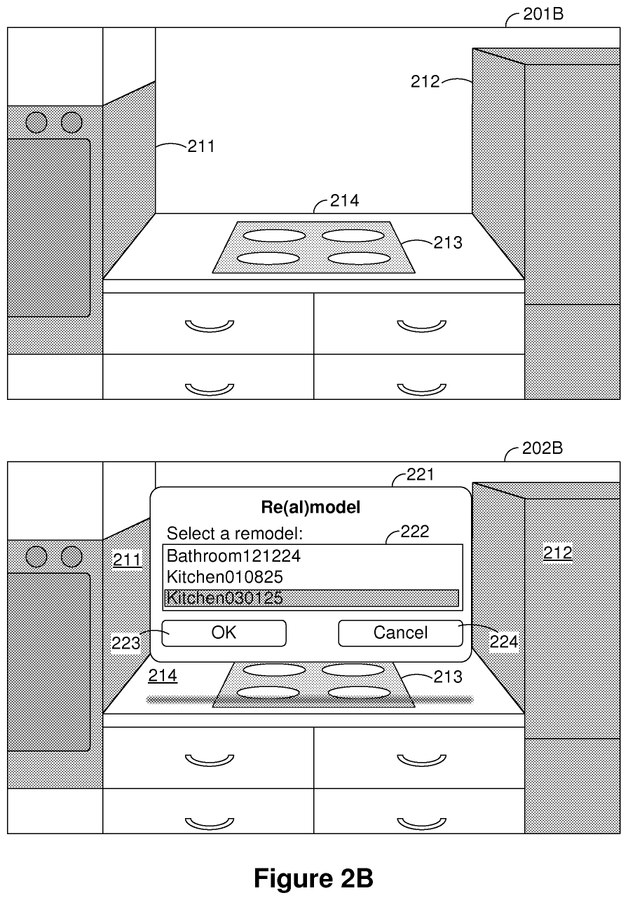

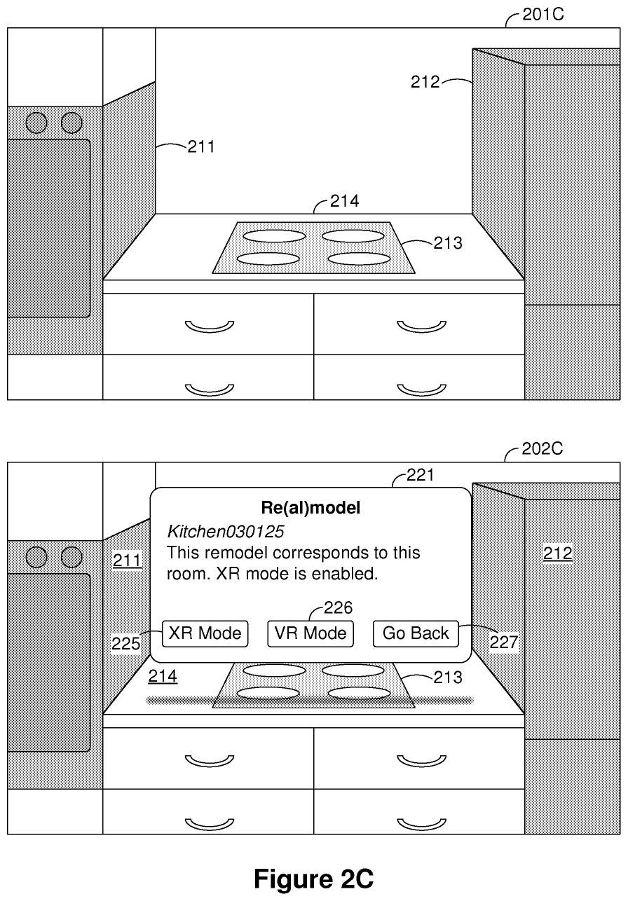

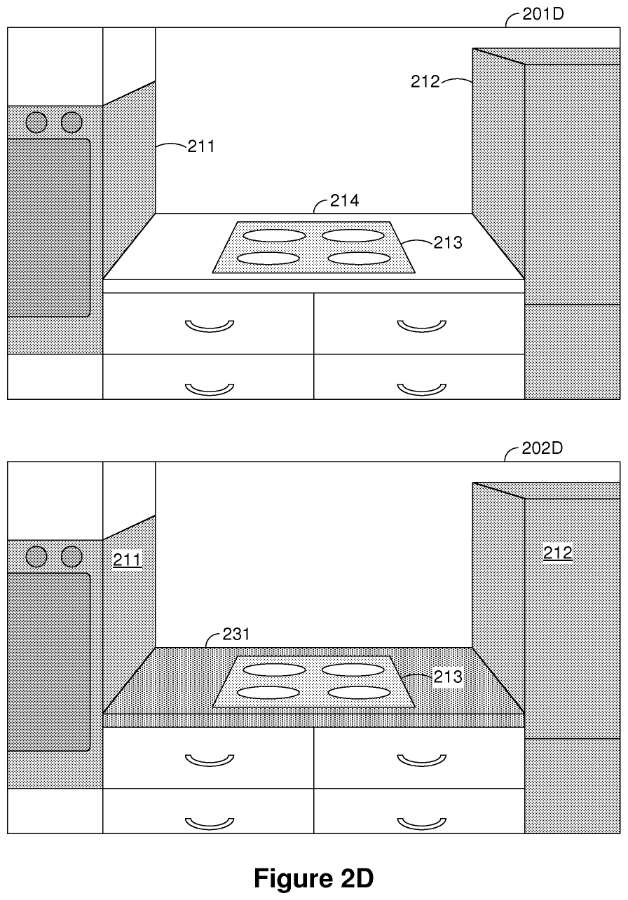

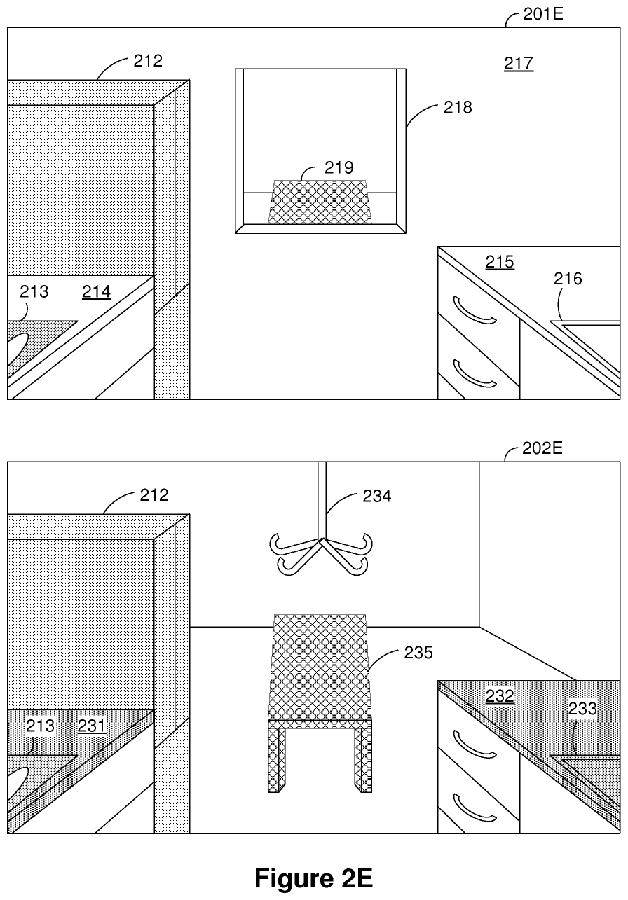

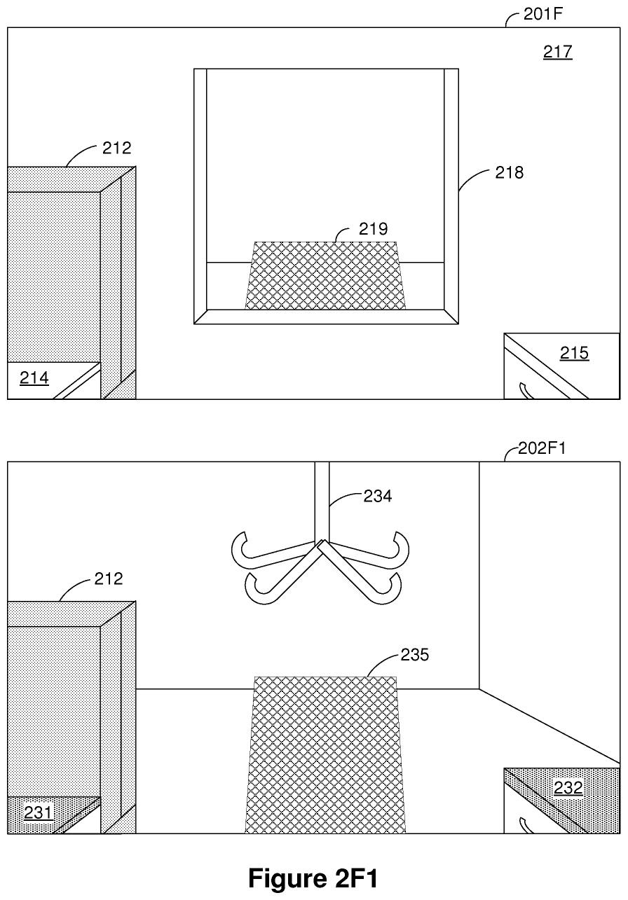

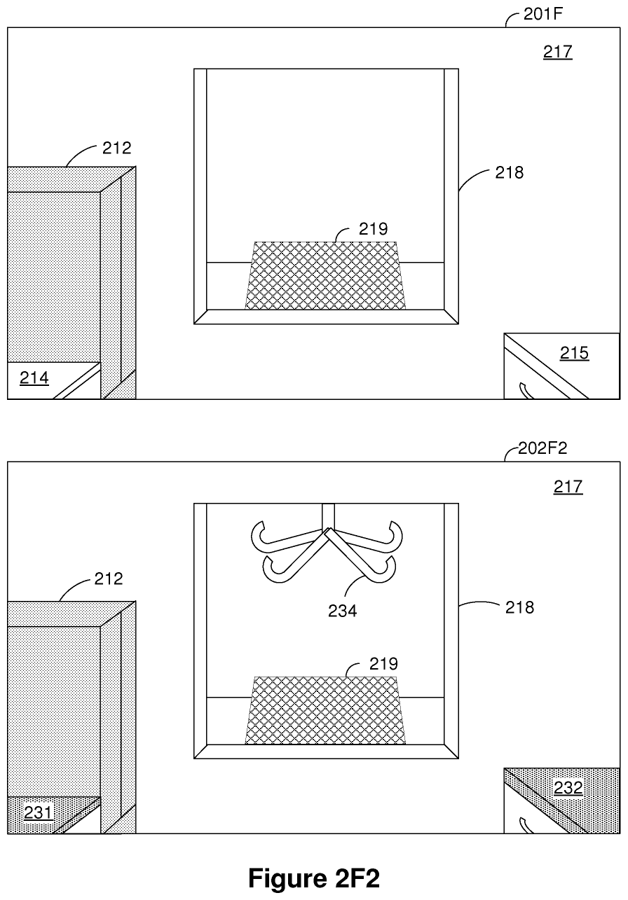

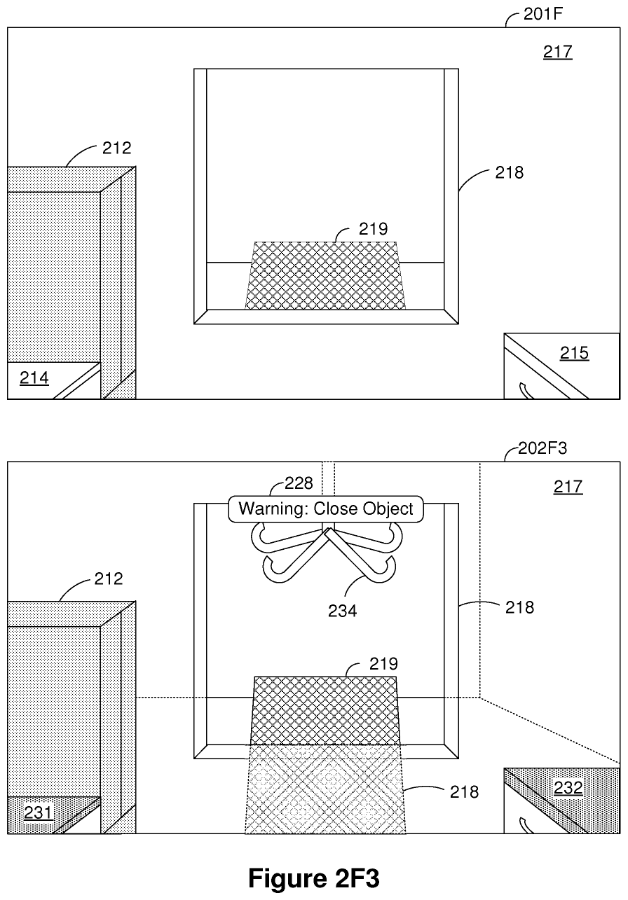

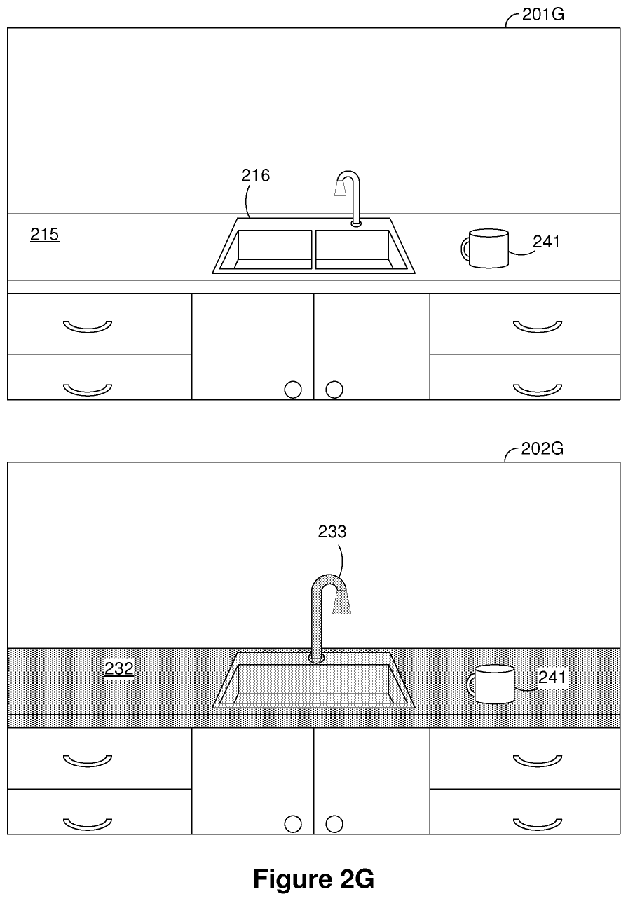

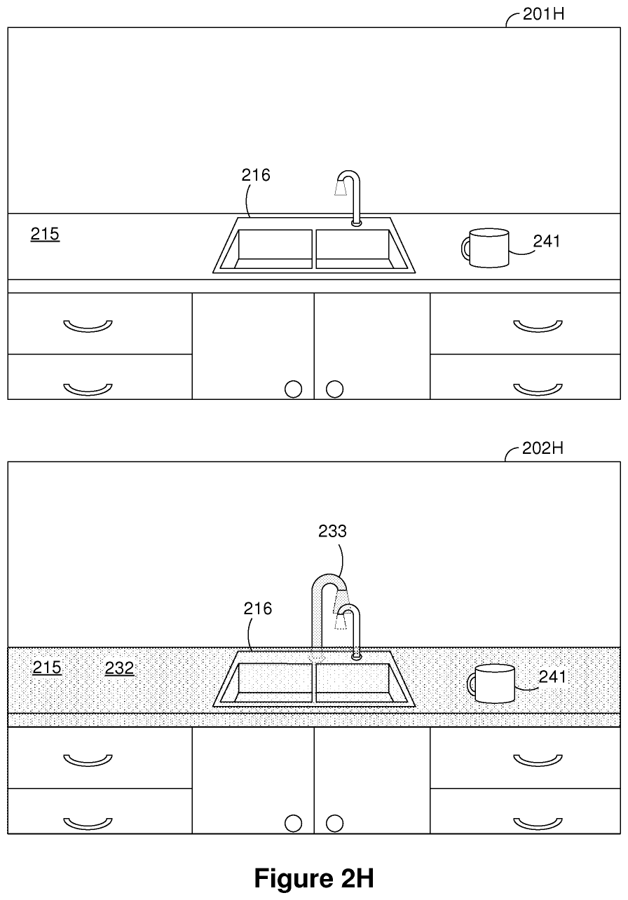

FIGS. 2A-2I illustrate a plurality of images of a first physical environment 201A-201I of a kitchen captured by an image sensor of an electronic device. Further, FIGS. 2A-2I further illustrate a plurality of images of a first XR environment 202A-202I displayed, at least in part, by a display of the electronic device. In various implementations, the electronic device includes multiple displays (e.g., a left display positioned in front of a left eye of a user and a right display positioned in front of a right eye of the user) configured to provide a stereoscopic view of the first XR environment. For ease of illustration, FIGS. 2A-2H illustrate the images of the first XR environment 202A-202I as presented on a single one of the multiple displays.

In various implementations, the images of the first physical environment 201A-201I are captured (and the images of the first XR environment 202A-202I are displayed) during a series of time periods. In various implementations, each time period is an instant, a fraction of a second, a few seconds, a few hours, a few days, or any length of time.

The images of the first XR environment 202A-202I are generated by compositing virtual content on top of the images of the first physical environment 201A-201I. Accordingly, physical objects captured in the images of the first physical environment 201A-201I are also displayed in the images of the first XR environment 202A-202I. Further, at least some of the images of the first XR environment 202A-202I include virtual objects.

In various implementations, certain objects are presented at a location in the XR environment, e.g., at a location defined by three coordinates in a three-dimensional (3D) XR coordinate system. Accordingly, when the electronic device moves in the first XR environment (e.g., changes either position and/or orientation), the objects are moved on the display of the electronic device, but retain their (possibly time-dependent) location in the first XR environment. Such virtual objects that, in response to motion of the electronic device, move on the display, but retain their position in the first XR environment are referred to as world-locked objects. In various implementations, certain virtual objects are displayed at locations on the display such that when the electronic device moves in the first XR environment, the objects are stationary on the display on the electronic device. Such virtual objects that, in response to motion of the electronic device, retain their location on the display are referred to as head-locked objects or display-locked objects.

FIG. 2A illustrates a first image of the first physical environment 201A captured during a first time period and a first image of the first XR environment 202A displayed during the first time period. The first image of the first physical environment 201A includes an oven 211, a refrigerator 212, a stove 213, and a stove countertop 214. Accordingly, the first image of the first XR environment 202A also includes the oven 211, the refrigerator 212, the stove 213, and the stove countertop 214. Additionally, the first image of the first XR environment 202A includes a model visualization window 221 floating in the first XR environment over the stove 213. The model visualization window 221 is a world-locked virtual object. The model visualization window 221 includes a model selection box 222 listing a number of available manually-manipulated 3D models, a confirmation affordance 223 for confirming a selection once made, and a cancel affordance 224 for dismissing the model visualization window 221.

FIG. 2B illustrates a second image of the first physical environment 201B captured during a second time period and a second image of the first XR environment 202B displayed during the second time period. Between the first time period and the second time period, the user has selected the “Kitchen030125” model in the model selection box 222. The second image of the first physical environment 201B includes the oven 211, refrigerator 212, stove 213, and stove countertop 214. Accordingly, the second image of the first XR environment 202B also includes the oven 211, refrigerator 212, stove 213, and stove countertop 214. In response to the user selecting the “Kitchen030125” model in the model selection box 222, the selected model is highlighted in the model selection box 222.

FIG. 2C illustrates a third image of the first physical environment 201C captured during a third time period and a third image of the first XR environment 202C displayed during the third time period. Between the second time period and the third time period, the user has selected the confirmation affordance 223. The third image of the first physical environment 201C includes the oven 211, refrigerator 212, stove 213, and stove countertop 214. Accordingly, the third image of the first XR environment 202C also includes the oven 211, refrigerator 212, stove 213, and stove countertop 214. In response to detecting the user selection of the confirmation affordance 223, the electronic device compares the selected manually-manipulated 3D model to a 3D model of the first physical environment. In various implementations, the electronic device passively generates the 3D model of the first physical environment as the user looks around. The 3D model of the first physical environment includes a number of points in a 3D coordinate system of the first XR environment. Each of the points represents a portion of an object in the first physical environment, such as a wall, a ceiling, a floor, an edge where two walls meet, a corner where two walls meet the ceiling or floor, the oven 211, the refrigerator 212, the stove 213, the stove countertop 214, or any other object in the first physical environment. In various implementations, the 3D model of the first physical environment further includes edges between the points, faces bounded by edges, and/or textures (e.g., color patterns or images) for the faces.

Similarly, the selected manually-manipulated 3D model similarly includes a number of points in a 3D coordinate system of the model. In various implementations, the manually-manipulated 3D model further includes edges between the points, faces bounded by edges, and/or textures for the faces. In various implementations, the manually-manipulated 3D model is generated from scratch by an author based on measurements and/or photographs of the first physical environment. In various implementations, the manually-manipulated 3D model is generated by an author editing a 3D model of the first physical environment.

As noted above, in response to detecting selection of the confirmation affordance 223, the electronic device compares the manually-manipulated 3D model to a 3D model of the first physical environment. In particular, the electronic device determines an affine transform of the manually-manipulated 3D model that minimizes an error function with respect to the 3D model of the first physical environment. In various implementations, the electronic device determines the affine transform which, when applied, minimizes the average distance between each point of the manually-manipulated 3D model and the 3D model of the first physical environment. In various implementations, the electronic device determines the affine transform which, when applied, maximizes the number of points of the manually-manipulated 3D model that are within a threshold distance of the 3D model of the first physical environment.

When the error function is below an error threshold, the model visualization window 221 indicates that the manually-manipulated 3D model corresponds to the first physical environment and indicates that an XR mode is enabled. The model visualization window 221 includes an XR mode affordance 225 to view the manually-manipulated 3D model in an XR mode, a VR mode affordance 226 to view the manually-manipulated 3D model in a VR mode, and a go-back affordance 227 to return to state in FIG. 2B including the model selection box 222.

However, as described further below, when the error function is above the error threshold, the model visualization window 221 indicates that the manually-manipulated 3D model does not correspond to the first physical environment and indicates that the XR mode is disabled. In such a case, the XR mode affordance is absent or grayed out and not selectable.

FIG. 2D illustrates a fourth image of the first physical environment 201D captured during a fourth time period and a fourth image of the first XR environment 202D displayed during the fourth time period. Between the third time period and the fourth time period, the user has selected the XR mode affordance 225. In response to detecting the user selection of the XR mode affordance 225, the electronic device applies the affine transform to the manually-manipulated 3D model generating a transformed 3D model and displays at least a portion of the transformed 3D model as virtual content in the first XR environment.

Thus, the fourth image of the first physical environment 201D includes the oven 211, the refrigerator 212, the stove 213, and the stove countertop 214. Similarly, the fourth image of the first XR environment 202D also includes the oven 211, the refrigerator 212, and the stove 213. However, rather than the stove countertop 214, the fourth image of the first XR environment 202D includes a virtual stove countertop 231 rendered according to the corresponding portion of the transformed 3D model.

Because the corresponding portions of the transformed 3D model are within a threshold degree of similarity to the corresponding portions of the 3D model of the physical environment, the fourth image of the first XR environment 202D includes the oven 211, the refrigerator 212, and the stove 213 rather than virtual versions rendered based on the transformed 3D model. However, because the corresponding portion of the transformed 3D model is sufficiently different from the corresponding portion of the 3D model of the physical environment (e.g., with different textures), the fourth image of the first XR environment 202D includes the virtual stove countertop 231 rather than the stove countertop 214.

FIG. 2E illustrates a fifth image of the first physical environment 201E captured during a fifth time period and a fifth image of the first XR environment 202E displayed during the fifth time period. Between the fourth time period and the fifth time period, the user has turned to the right. The fifth image of the first physical environment 201E includes the refrigerator 212, the stove 213, the stove countertop 214, a sink countertop 215, a sink 216, a wall 217, a serving window 218 cut out of the wall 217, and a table 219. The fifth image of the first XR environment 202E includes the refrigerator 212 and the stove 213. The fifth image of the first XR environment 202E further includes the virtual stove countertop 231, a virtual sink countertop 232, a virtual sink 233, a virtual light fixture 234, and a virtual table 235 rendered according to the corresponding portions of the transformed 3D model. Further, because the transformed 3D model does not include a portion corresponding to the wall 217, the fifth image of the first XR environment 202E does not include the wall 217. At the corresponding locations, the fifth image of the first XR environment 202E includes pixels with pixel values rendered according to the transformed 3D model.

FIG. 2F1 illustrates a sixth image of the first physical environment 201F captured during a sixth time period and a sixth image of the first XR environment 202F1 displayed during the sixth time period according to a first embodiment. Between the fifth time period and the sixth time period, the user has stepped forward. The sixth image of the first physical environment 201F includes the refrigerator 212, the stove countertop 214, the sink countertop 215, the wall 217, the serving window 218, and the table 219. The sixth image of the first XR environment 202F1 includes the refrigerator 212. The sixth image of the first XR environment 202F1 further includes the virtual stove countertop 231, the virtual sink countertop 232, the virtual light fixture 234, and the virtual table 235 rendered according to the corresponding portions of the transformed 3D model. As in FIG. 2E, because the transformed 3D model does not include a portion corresponding to the wall 217, the sixth image of the first XR environment 202F1 does not include the wall 217. At the corresponding locations, the sixth image of the first XR environment 202F1 includes pixels with pixel values rendered according to the transformed 3D model.

FIG. 2F2 illustrates the sixth image of the first physical environment 201F captured during a sixth time period and a sixth image of the first XR environment 202F2 displayed during the sixth time period according to a second embodiment. In FIG. 2F2 (unlike FIG. 2F1), the sixth image of the first XR environment 202F2 includes the wall 217 and the serving window 218. In various implementations, when the user is proximate to an object that does not have a corresponding portion in the transformed 3D model, the object is nevertheless displayed to prevent a user from collision with the object (e.g., walking into the wall 217).

FIG. 2F3 illustrates the sixth image of the first physical environment 201F captured during a sixth time period and a sixth image of the first XR environment 202F3 displayed during the sixth time period according to a third embodiment. In various implementations, when the user is proximate to an object that does not have a corresponding portion in the transformed 3D model, the object is nevertheless at least partially displayed to prevent a user from collision with the object (e.g., walking into the wall 217). In FIG. 2F3 (like FIG. 2F2), the sixth image of the first XR environment 202F3 includes the wall 217 and the serving window 218, however, in FIG. 2F3, the wall 217 is partially transparent. Thus, the pixel values of pixels corresponding to the wall 217 in the sixth image of the first XR environment 202F3 are a blend of the pixel values of the wall 217 in the sixth image of the first physical environment 201F and pixel values rendered based on the transformed 3D model. Further, in various implementations, the sixth image of the first XR environment 202F3 includes a warning window 228 indicating that the user is proximate to an object. In various implementations, the warning window 228 is a display-locked object.

FIG. 2G illustrates a seventh image of the first physical environment 201G captured during a seventh time period and a seventh image of the first XR environment 202G displayed during the seventh time period. Between the sixth time period and the seventh time period, the user has stepped back and turned right. The seventh image of the first physical environment 201G includes the sink countertop 215, the sink 216, and a mug 241. The seventh image of the first XR environment 202G includes the virtual sink countertop 232 and the virtual sink 233 rendered according to the corresponding portions of the transformed 3D model. Further, the seventh image of the first XR environment 202G includes the mug 241. In various implementations, when the transformed 3D model does not include a portion that corresponds to a portion of the 3D model of the first physical environment, pixels in those locations are rendered based on the transformed 3D model (e.g., as in FIG. 2E for the wall 217). However, in various implementations, when the transformed 3D model does not include a portion that corresponds to the 3D model of the first physical environment, pixels in those locations are passed through from the image of the first physical environment (e.g., as in FIG. 2G for the mug 241).

In various implementations, when the transformed 3D model does not include a portion that corresponds to a portion of the 3D model of the first physical environment, the electronic device determines whether to display pixels in those locations rendered based on the transformed 3D model or based on the image of the first physical environment. In various implementations, the electronic device makes the determination based on a size of the portion. For example, the wall 217 is much larger than the mug 241. In various implementations, the electronic device makes the determination based on an object type of the object. For example, for fixed items (such as walls, counters, or a kitchen island), the electronic device renders the pixels based on the transformed 3D model, but for moveable items (such as a mug, a book, a pet, or a person), the electronic device passes through the pixels from the image of the first physical environment.

FIG. 2H illustrates an eighth image of the first physical environment 201H captured during an eighth time period and an eighth image of the first XR environment 202H displayed during the eighth time period. Between the seventh time period and the eighth time period, the user has set a transparency of the virtual content to 50%. The eighth image of the first physical environment 201H includes the sink countertop 215, the sink 216, and the mug 241. The eighth image of the first XR environment 202H includes the sink countertop 215, the sink 216, the mug 241, the virtual sink countertop 232, and the virtual sink 233. At the locations of the virtual sink countertop 232 and the virtual sink 233, the pixel values of the pixels are a blend of the pixel values generated by rendering the corresponding portions of the transformed 3D model and the corresponding pixel values of the eighth image of the first physical environment 201H. By changing the opacity of the virtual content, the user can more clearly see what changes are being proposed and the end result.

FIG. 2I illustrates a ninth image of the first physical environment 201I captured during a ninth time period and a ninth image of the first XR environment 202I displayed during the ninth time period. Between the eighth time period and the ninth time period, the user has activated an internals view. The eighth image of the first physical environment 202I includes the sink countertop 215, the sink 216, and the mug 241. The ninth image of the first XR environment 202I includes the sink countertop 215, the sink 216, the mug 241, the virtual sink countertop 232, and the virtual sink 233. As in the eighth image, at the locations of the virtual sink countertop 232 and the virtual sink 233, the pixel values of the pixels are a blend of the pixel values generated by rendering the corresponding portions of the transformed 3D model and the corresponding pixels of the ninth image of the first physical environment 201I.

The ninth image of the first XR environment 202I further includes virtual current source plumbing 251 and virtual current drain plumbing 252. Although the virtual current source plumbing 251 and virtual current drain plumbing 252 are virtual objects that do not appear in the ninth image of the first physical environment 201I, they correspond to real objects in the first physical environment that are hidden. In various implementations, the virtual current plumbing are rendered based on portions of the transformed 3D model marked as “current” or “real” objects.

The ninth image of the first XR environment 202I further includes virtual renovated source plumbing 261 and virtual renovated drain plumbing 262. The virtual renovated source plumbing 261 and the virtual renovated drain plumbing 262 are virtual objects that do not correspond to real objects in the first physical environment, but correspond to object in the transformed 3D model. In various implementations, the virtual renovated plumbing are rendered based on portions of the transformed 3D model marked as “new” or “changed” or “renovated” objects.

At the locations where the virtual current plumbing and the virtual renovated plumbing overlap (particularly when the transparency of the virtual content is set to 50%), the pixel values are a blend of pixel values generated by rendering the “current” objects and pixel values generated by rendering the “renovated” object.

By displaying internal (or hidden) objects, the user can further more clearly see what changes are being proposed and assess costs associated with the proposed changes. In various implementations, when the user has activated the internals view, an image of the first XR environment includes objects hidden by walls or cabinetry, such as one or more of studs, plumbing, electrical wiring, HVAC ducting and venting, etc.

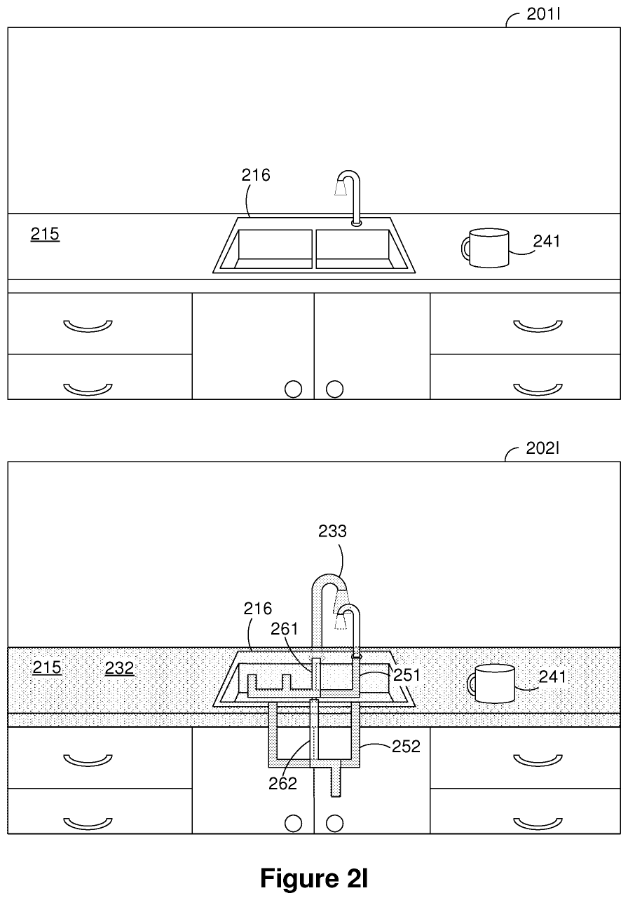

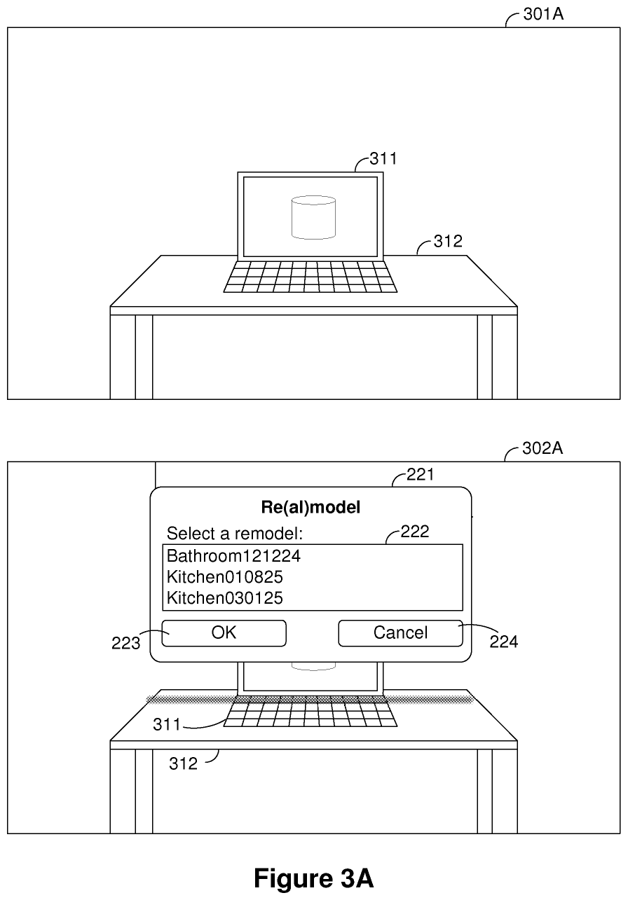

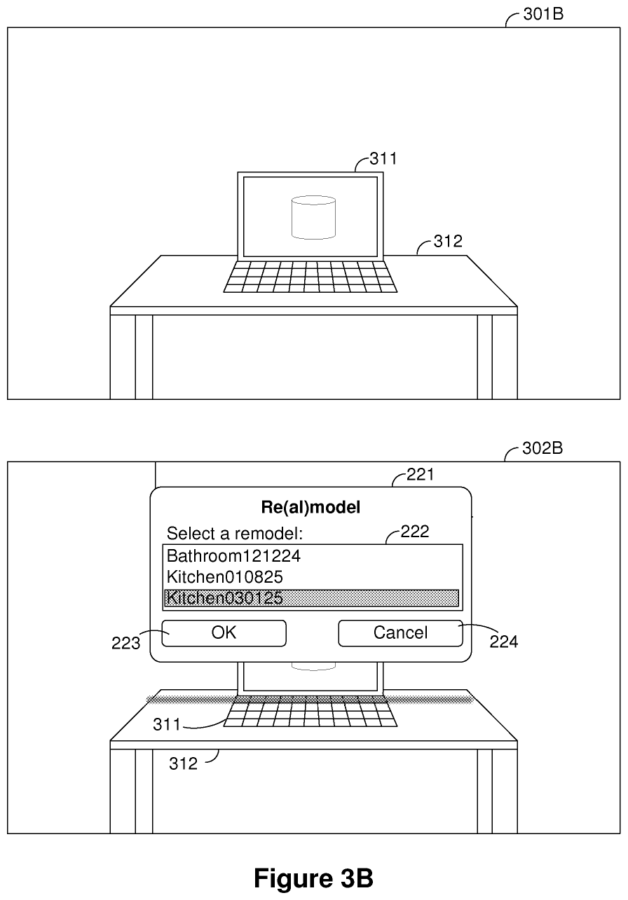

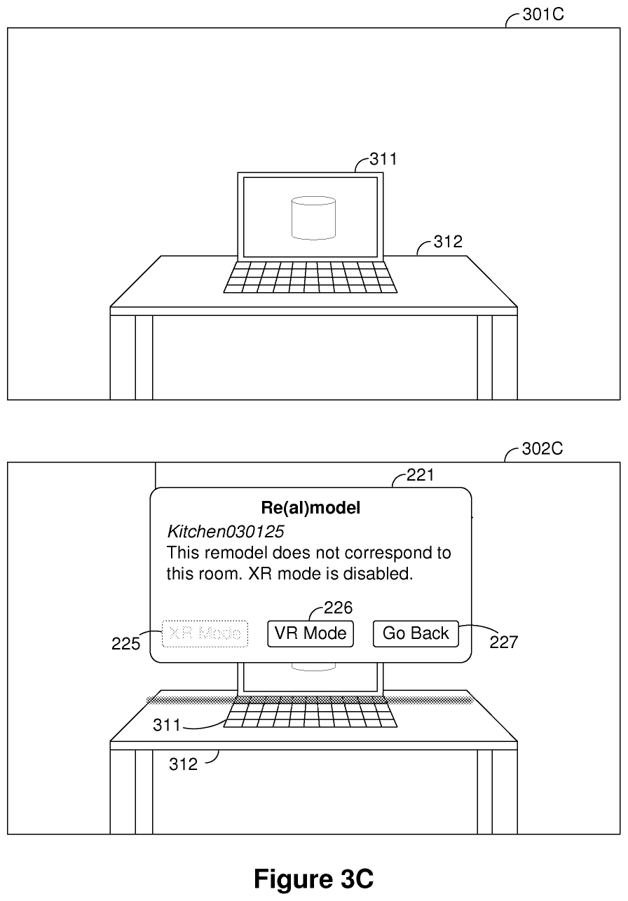

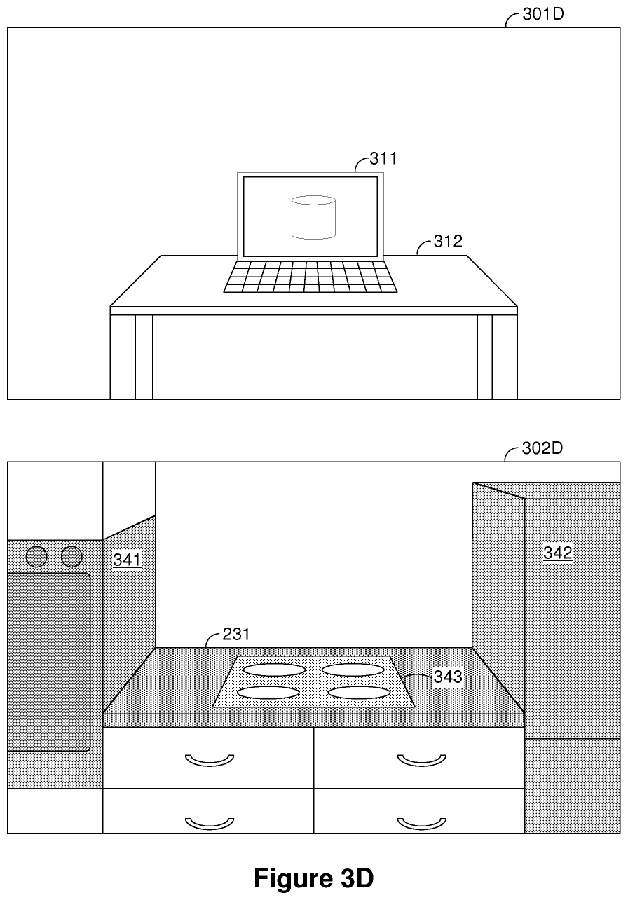

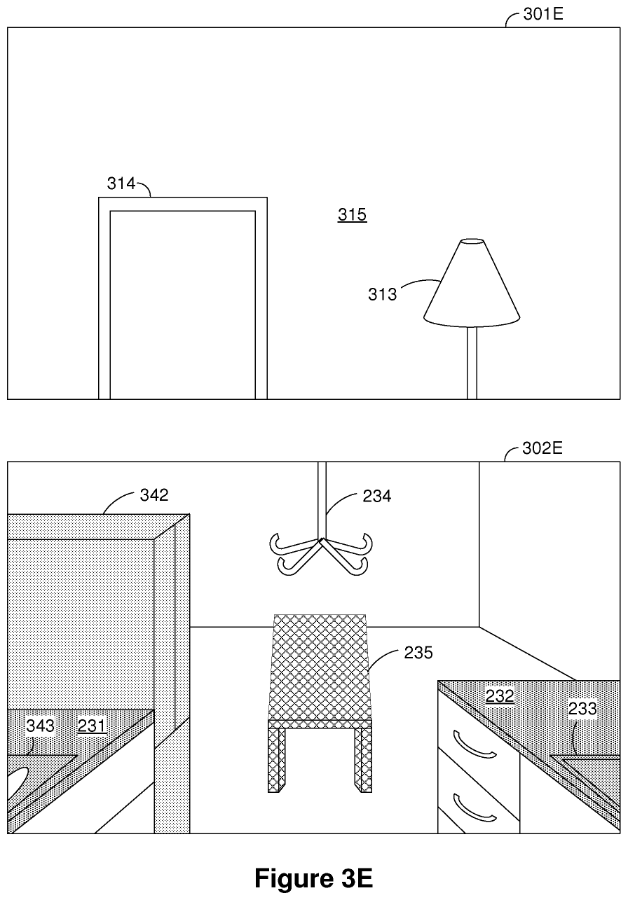

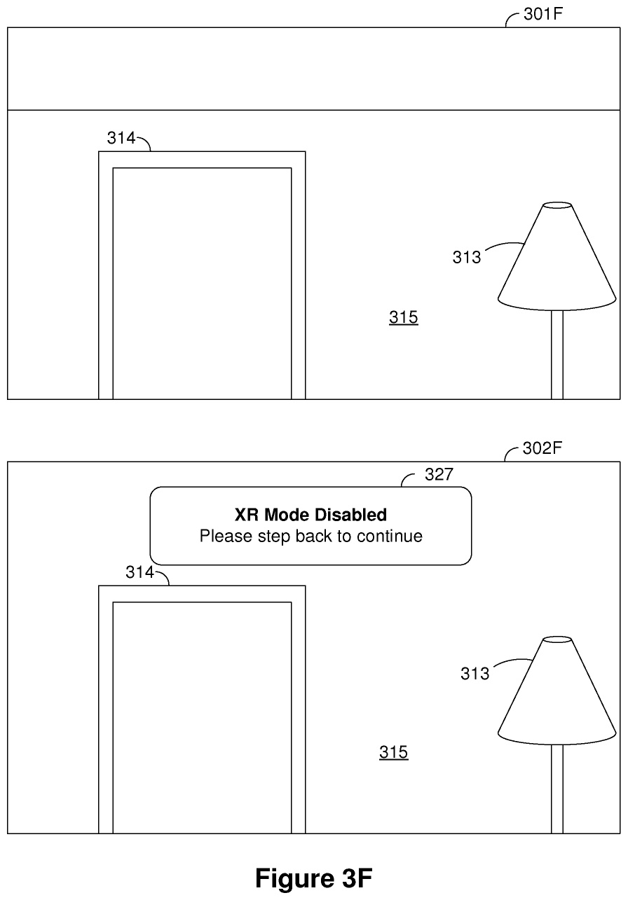

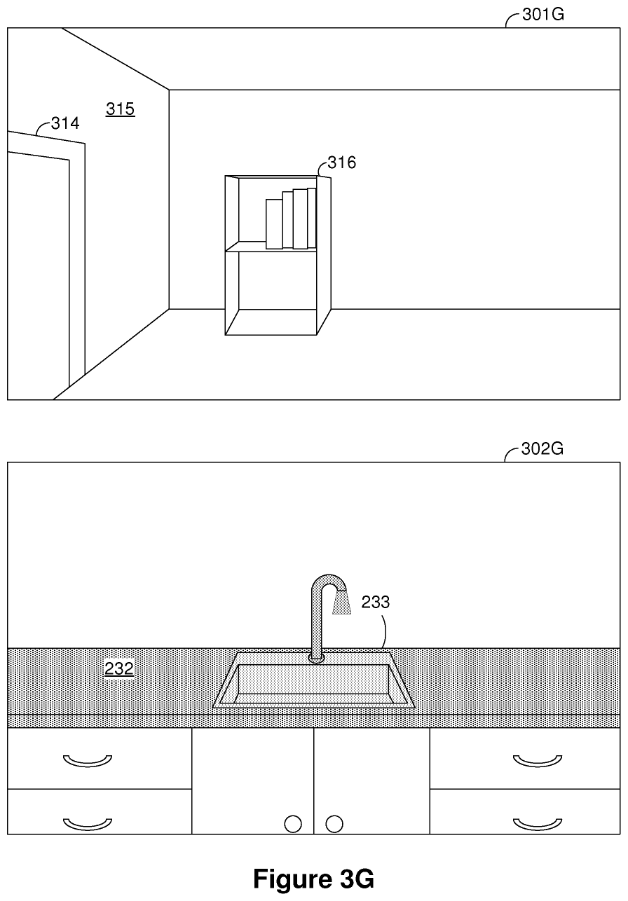

FIGS. 3A-3G illustrate a plurality of images of a second physical environment 301A-301G of an office captured by an image sensor of an electronic device. Further, FIGS. 3A-3G further illustrate a plurality of images of a second XR environment 302A-302G displayed, at least in part, by a display of the electronic device. In various implementations, the electronic device includes multiple displays (e.g., a left display positioned in front of a left eye of a user and a right display positioned in front of a right eye of the user) configured to provide a stereoscopic view of the second XR environment. For ease of illustration, FIGS. 3A-3G illustrate the images of the second XR environment 302A-302G as presented on a single one of the multiple displays.

In various implementations, the images of the second physical environment 301A-301G are captured (and the images of the second XR environment 302A-302G are displayed) during a series of time periods. In various implementations, each time period is an instant, a fraction of a second, a few seconds, a few hours, a few days, or any length of time.

The images of the second XR environment 302A-302G are generated by compositing virtual content on top of the images of the second physical environment 301A-301G. Accordingly, physical objects captured in the images of the second physical environment 301A-301G are also displayed in the images of the second XR environment 302A-302G. Further, at least some of the images of the second XR environment 302A-302G include virtual objects.

FIG. 3A illustrates a first image of the second physical environment 301A captured during a first time period and a first image of the second XR environment 302A displayed during the first time period. The first image of the second physical environment 301A includes a laptop 311 and a desk 312. Accordingly, the first image of the second XR environment 302A also includes the laptop 311 and the desk 312. Additionally, the first image of the second XR environment 302A includes the model visualization window 221 floating in the second XR environment over the desk 312.

FIG. 3B illustrates a second image of the second physical environment 301B captured during a second time period and a second image of the second XR environment 302B displayed during the second time period. Between the first time period and the second time period, the user has selected the “Kitchen030125” model in the model selection box 222. The second image of the second physical environment 301B includes the laptop 311 and the desk 312. Accordingly, the second image of the second XR environment 302B also includes the the laptop 311 and the desk 312. In response to the user selecting the “Kitchen030125” model in the model selection box 222, the selected model is highlighted in the model selection box 222.

FIG. 3C illustrates a third image of the second physical environment 301C captured during a third time period and a third image of the second XR environment 302C displayed during the third time period. Between the second time period and the third time period, the user has selected the confirmation affordance 223. The third image of the second physical environment 301C includes the laptop 311 and the desk 312. Accordingly, the third image of the second XR environment 302C also includes the laptop 311 and the desk 312. In response to detecting the user selection of the confirmation affordance 223, the electronic device compares the selected manually-manipulated 3D model to a 3D model of the second physical environment. In particular, the electronic device determines an affine transform of the manually-manipulated 3D model that minimizes an error function with respect to the 3D model of the second physical environment.

As illustrated in FIG. 3C, when the error function is above the error threshold, the model visualization window 221 indicates that the manually-manipulated 3D model does not correspond to the second physical environment and indicates that the XR mode is disabled. In such a case, the XR mode affordance 225 is absent or grayed out and not selectable.

FIG. 3D illustrates a fourth image of the second physical environment 301D captured during a fourth time period and a fourth image of the second XR environment 302D displayed during the fourth time period. Between the third time period and the fourth time period, the user has selected the VR mode affordance 226. In response to detecting the user selection of the VR mode affordance 226, the electronic device displays the manually-manipulated 3D model.

Thus, the fourth image of the second physical environment 301D includes the laptop 311 and the desk 312. However, the fourth image of the second XR environment 302D does not include the laptop 311 or the desk 312, but includes the virtual stove countertop 231, a virtual oven 341, a virtual refrigerator 342, and a virtual stove 343 rendered according to the corresponding portion of the manually-manipulated 3D model.

FIG. 3E illustrates a fifth image of the second physical environment 301E captured during a fifth time period and a fifth image of the second XR environment 302E displayed during the fifth time period. Between the fourth time period and the fifth time period, the user has turned to the right. The fifth image of the second physical environment 301E includes a lamp 313, a door 314, and a wall 315. The fifth image of the second XR environment 302E does not include the lamp 313, the door 314, or the wall 315, but includes the virtual stove countertop 231, the virtual sink countertop 232, the virtual sink 233, the virtual light fixture 234, the virtual table 235, the virtual refrigerator 342, and the virtual stove 343.

FIG. 3F illustrates a sixth image of the second physical environment 301F captured during a sixth time period and a sixth image of the second XR environment 302F displayed during the sixth time period. Between the fifth time period and the sixth time period, the user has stepped forward. The sixth image of the second physical environment 301F includes the lamp 313, the door 314, and the wall 315. Similarly, the sixth image of the second XR environment 302F includes the lamp 313, the door 314, and the wall 315. In the VR mode, in response to a change in position (as opposed to orientation) of a threshold distance, the electronic device ceases display of the manually-manipulated 3D model. In various implementations, the electronic device indicates when this has occurred. For example, the sixth image of the second physical environment 301F includes the information window 327 indicating that AR mode is disabled and providing instructions to return to the original location to continue.

FIG. 3G illustrates a seventh image of the second physical environment 301G captured during a seventh time period and a seventh image of the second XR environment 302G displayed during the seventh time period. Between the sixth time period and the seventh time period, the user has stepped back and turned right. The seventh image of the second physical environment 301G includes the door 314, the wall 315, and a bookcase 316. The seventh image of the second XR environment 302G does not include the door 314, the wall 315, or the bookcase 316, but includes the virtual sink countertop 232 and the virtual sink 233. Further, unlike the seventh image of the first XR environment 202G, the seventh image of the second XR environment 302G does not include the mug 241.

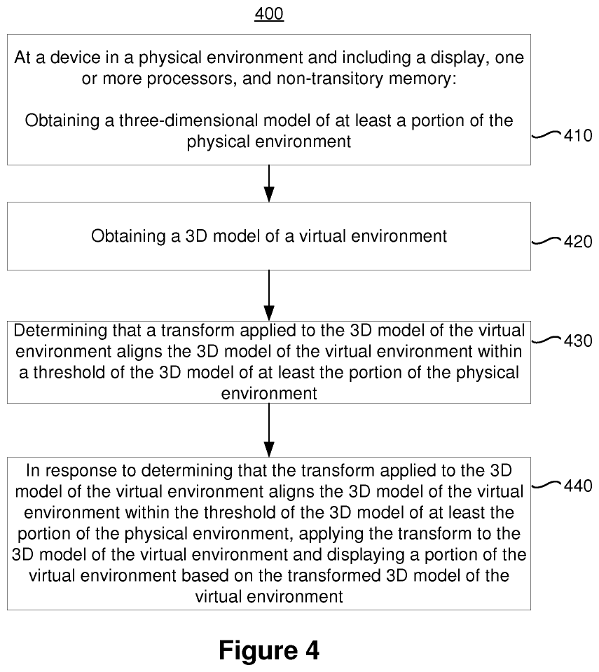

FIG. 4 is a flowchart representation of a method 400 of displaying a virtual environment in accordance with some implementations. In various implementations, the method 400 is performed by an electronic device, such as the electronic device 120 of FIG. 1. In various implementations, the method 400 is performed by a device in a physical environment and including a display, one or more processors, and non-transitory memory. In some implementations, the method 400 is performed by processing logic, including hardware, firmware, software, or a combination thereof. In some implementations, the method 400 is performed by a processor executing instructions (e.g., code) stored in a non-transitory computer-readable medium (e.g., a memory).

The method 400 begins, in block 410, with the device obtaining a three-dimensional (3D) model of at least a portion of the physical environment. The 3D model of at least the portion of the physical environment includes a number of points in a 3D coordinate system of the physical environment. Each of the points represents a portion of an object in the physical environment. In various implementations, the 3D model of at least the portion the physical environment further includes edges between the points, faces bounded by edges, and/or textures (e.g., color patterns or images) for the faces. Thus, in various implementations, the 3D model of at least the portion of the physical environment includes 3D models of one or more physical (or real) objects.

The method 400 continues, in block 420, with the device obtaining a 3D model of a virtual environment. The 3D model of the virtual environment includes a number of points in a 3D coordinate system of the virtual environment. In various implementations, the 3D model of the virtual environment further includes edges between the points, faces bounded by edges, and/or textures for the faces. In various implementations, the 3D model of the virtual environment is generated from scratch by an author based on measurements and/or photographs of the physical environment. Thus, in various implementations, the 3D model of the virtual environment includes 3D models of one or more virtual objects. In various implementations, the 3D model of the virtual environment is generated by an author editing a 3D model of the physical environment. Thus, in various implementations, the 3D model of the virtual environment includes 3D models of one or more virtual objects and 3D models of one or more physical objects.

The method 400 continues, in block 430, with the device determining that a transform applied to the 3D model of the virtual environment aligns the 3D model of the virtual environment within a threshold of the 3D model of at least the portion of the physical environment. For example, in various implementations, determining that the transform applied to the 3D model of the virtual environment aligns the 3D model of the virtual environment within a threshold of the 3D model of at least the portion of the physical environment includes determining that an alignment score of the transform is above a threshold score. In various implementations, the transform includes a translation of the 3D coordinate system of the virtual environment. In various implementation, the transform includes a rotation of the 3D coordinate system of the virtual environment. In various implementations, the transform includes a scaling of the 3D coordinate system of the virtual environment.

In various implementations, the alignment score is indicative of an alignment of the virtual environment with the physical environment once the transform is applied. For example, in various implementations, the alignment score is determined based on the distance between each point in the transformed 3D model of the virtual environment to the closest point in the 3D model of at least the portion of the physical environment. As another example, in various implementations, the alignment score is determined based on a number of points of the transformed 3D model of the virtual environment that are within a threshold distance of the 3D model of at least the portion of the physical environment.

The method 400 continues, in block 440, with the device, in response to determining that the transform applied to the 3D model of the virtual environment aligns the 3D model of the virtual environment within the threshold of the 3D model of at least the portion of the physical environment, applying the transform to the 3D model of the virtual environment and displaying a portion of the virtual environment based on the transformed 3D model of the virtual environment. For example, in various implementations, displaying the portion of the virtual environment includes rendering a portion of the transformed 3D model of the virtual environment. For example, in FIG. 2D, in response to the manually-manipulated 3D model being able to be transformed to align with the first physical environment, the first XR environment includes the virtual stove countertop 231. In various implementations, displaying the portion of the virtual environment includes determining the portion of the virtual environment to be displayed. For example, in FIG. 2D, the fourth image of the first XR environment 202D includes the virtual stove countertop 231, but does not include the virtual refrigerator 342. In various implementations, determining the portion of the virtual environment to be displayed includes determining that the portion of the virtual environment is at least a threshold amount different than a corresponding portion of the physical environment. In various implementations, determining that the portion of the virtual environment is at least a threshold amount different than the corresponding portion of the physical environment includes comparing a geometry of the portion of the virtual environment and a geometry of the portion of the physical environment. For example, in FIG. 2E, the fifth image of the first XR environment 202E includes the virtual table 235 because the geometry of the manually-manipulated 3D model does not include the wall 217 whereas the geometry of the first physical environment does include the wall 217. In various implementations, determining that the portion of the virtual environment is at least a threshold amount different than the corresponding portion of the physical environment includes comparing a color of the portion of the virtual environment and a color of the portion of the physical environment. For example, in FIG. 2E, the fifth image of the first XR environment 202E includes the virtual sink countertop 232 because the texture of the corresponding portion of the manually-manipulated 3D model is different than the texture of the corresponding portion of the first physical environment.

In various implementations, displaying the portion of the virtual environment includes displaying one or more concealed objects. For example, in FIG. 2I, the ninth image of the first XR environment includes the virtual renovated source plumbing 261 and the virtual renovated drain plumbing 262.

In various implementations, determining the portion of the virtual environment to be displayed includes determining that the portion of the physical environment to be displayed. For example, in FIG. 2F2, the sixth image of the first XR environment 202F2 includes the wall 217 because the user is close to the wall 217. Thus, in various implementations, determining the portion of the physical environment is based on a proximity of the portion of the physical environment. In various implementations, the method 400 further includes displaying a notification indicating the proximity. For example, in FIG. 2F3, the sixth image of the first XR environment 202F3 includes the warning window 228. In various implementations, determining the portion of the physical environment is based on an object type of the portion of the physical environment. For example, in FIG. 2G, the seventh image of the first XR environment 202G includes the mug 241 based on the mug 241 being a small and/or movable object.

In various implementations, the method 400 includes displaying the portion of the physical environment. In various implementations, displaying the portion of the physical environment includes displaying the portion of the physical environment at a same location as the portion of the virtual environment. For example, in FIG. 2H, the eighth image of the first XR environment 202H includes the sink 216 and the virtual sink 233 at the same location. In various implementations, the method 400 includes receiving user input indicative of an opacity and displaying the portion of the physical environment at the same location as the portion of the virtual environment includes displaying the portion of the virtual environment with the opacity.

In various implementations, displaying the virtual environment is based on lighting of the physical environment. For example, in FIG. 2D, the fourth image of the first XR environment 202D can include the virtual stove countertop 231 rendered according the lighting in the first physical environment. In various implementations, displaying the portion of the physical environment is based on lighting of the virtual environment. For example, in FIG. 2E, the fifth image of the first XR environment 202E can include the refrigerator 212 altered based on the light from the virtual light fixture 234.

In various implementations, the method 400 includes, in response to determining that the transform applied to the 3D model of the virtual environment does not align the 3D model of the virtual environment within the threshold of the 3D model of at least the portion of the physical environment, displaying the virtual environment based on the 3D model of the virtual environment. For example, in FIG. 3D, the fourth image of the second XR environment 302D includes the virtual stove countertop 231 and the virtual refrigerator 342. In various implementations, the method 400 includes, while displaying the virtual environment based on the 3D model of the virtual environment, detecting a change in position of the device and, in response to detecting the change in position, ceasing to display the virtual environment. For example, in FIG. 3F, the sixth image of the second XR environment 302F does not include any part rendered according to the manually-manipulated 3D model.

FIG. 5 is a block diagram of an example of the controller 110 in accordance with some implementations. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the controller 110 includes one or more processing units 502 (e.g., microprocessors, application-specific integrated-circuits (ASICs), field-programmable gate arrays (FPGAs), graphics processing units (GPUs), central processing units (CPUs), processing cores, and/or the like), one or more input/output (I/O) devices 506, one or more communication interfaces 508 (e.g., universal serial bus (USB), FIREWIRE, THUNDERBOLT, IEEE 802.3x, IEEE 802.11x, IEEE 802.16x, global system for mobile communications (GSM), code division multiple access (CDMA), time division multiple access (TDMA), global positioning system (GPS), infrared (IR), BLUETOOTH, ZIGBEE, and/or the like type interface), one or more programming (e.g., I/O) interfaces 510, a memory 520, and one or more communication buses 504 for interconnecting these and various other components.

In some implementations, the one or more communication buses 504 include circuitry that interconnects and controls communications between system components. In some implementations, the one or more I/O devices 506 include at least one of a keyboard, a mouse, a touchpad, a joystick, one or more microphones, one or more speakers, one or more image sensors, one or more displays, and/or the like.

The memory 520 includes high-speed random-access memory, such as dynamic random-access memory (DRAM), static random-access memory (SRAM), double-data-rate random-access memory (DDR RAM), or other random-access solid-state memory devices. In some implementations, the memory 520 includes non-volatile memory, such as one or more magnetic disk storage devices, optical disk storage devices, flash memory devices, or other non-volatile solid-state storage devices. The memory 520 optionally includes one or more storage devices remotely located from the one or more processing units 502. The memory 520 comprises a non-transitory computer readable storage medium. In some implementations, the memory 520 or the non-transitory computer readable storage medium of the memory 520 stores the following programs, modules and data structures, or a subset thereof including an optional operating system 530 and an XR experience module 540.

The operating system 530 includes procedures for handling various basic system services and for performing hardware dependent tasks. In some implementations, the XR experience module 540 is configured to manage and coordinate one or more XR experiences for one or more users (e.g., a single XR experience for one or more users, or multiple XR experiences for respective groups of one or more users). To that end, in various implementations, the XR experience module 540 includes a data obtaining unit 542, a tracking unit 544, a coordination unit 546, and a data transmitting unit 548.

In some implementations, the data obtaining unit 542 is configured to obtain data (e.g., presentation data, interaction data, sensor data, location data, etc.) from at least the electronic device 120 of FIG. 1. To that end, in various implementations, the data obtaining unit 542 includes instructions and/or logic therefor, and heuristics and metadata therefor.

In some implementations, the tracking unit 544 is configured to map the physical environment 105 and to track the position/location of at least the electronic device 120 with respect to the physical environment 105 of FIG. 1. To that end, in various implementations, the tracking unit 544 includes instructions and/or logic therefor, and heuristics and metadata therefor.

In some implementations, the coordination unit 546 is configured to manage and coordinate the XR experience presented to the user by the electronic device 120. To that end, in various implementations, the coordination unit 546 includes instructions and/or logic therefor, and heuristics and metadata therefor.

In some implementations, the data transmitting unit 548 is configured to transmit data (e.g., presentation data, location data, etc.) to at least the electronic device 120. To that end, in various implementations, the data transmitting unit 548 includes instructions and/or logic therefor, and heuristics and metadata therefor.

Although the data obtaining unit 542, the tracking unit 544, the coordination unit 546, and the data transmitting unit 548 are shown as residing on a single device (e.g., the controller 110), it should be understood that in other implementations, any combination of the data obtaining unit 542, the tracking unit 544, the coordination unit 546, and the data transmitting unit 548 may be located in separate computing devices.

Moreover, FIG. 5 is intended more as functional description of the various features that may be present in a particular implementation as opposed to a structural schematic of the implementations described herein. As recognized by those of ordinary skill in the art, items shown separately could be combined and some items could be separated. For example, some functional modules shown separately in FIG. 5 could be implemented in a single module and the various functions of single functional blocks could be implemented by one or more functional blocks in various implementations. The actual number of modules and the division of particular functions and how features are allocated among them will vary from one implementation to another and, in some implementations, depends in part on the particular combination of hardware, software, and/or firmware chosen for a particular implementation.

FIG. 6 is a block diagram of an example of the electronic device 120 in accordance with some implementations. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the electronic device 120 includes one or more processing units 602 (e.g., microprocessors, ASICs, FPGAs, GPUs, CPUs, processing cores, and/or the like), one or more input/output (I/O) devices and sensors 606, one or more communication interfaces 608 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, and/or the like type interface), one or more programming (e.g., I/O) interfaces 610, one or more XR displays 612, one or more optional interior-and/or exterior-facing image sensors 614, a memory 620, and one or more communication buses 604 for interconnecting these and various other components.

In some implementations, the one or more communication buses 604 include circuitry that interconnects and controls communications between system components. In some implementations, the one or more I/O devices and sensors 606 include at least one of an inertial measurement unit (IMU), an accelerometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some implementations, the one or more XR displays 612 are configured to provide the XR experience to the user. In some implementations, the one or more XR displays 612 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electro-mechanical system (MEMS), and/or the like display types. In some implementations, the one or more XR displays 612 correspond to diffractive, reflective, polarized, holographic, etc. waveguide displays. For example, the electronic device 120 includes a single XR display. In another example, the electronic device includes an XR display for each eye of the user. In some implementations, the one or more XR displays 612 are capable of presenting MR and VR content.

In some implementations, the one or more image sensors 614 are configured to obtain image data that corresponds to at least a portion of the face of the user that includes the eyes of the user (any may be referred to as an eye-tracking camera). In some implementations, the one or more image sensors 614 are configured to be forward-facing so as to obtain image data that corresponds to the physical environment as would be viewed by the user if the electronic device 120 was not present (and may be referred to as a scene camera). The one or more optional image sensors 614 can include one or more RGB cameras (e.g., with a complimentary metal-oxide-semiconductor (CMOS) image sensor or a charge-coupled device (CCD) image sensor), one or more infrared (IR) cameras, one or more event-based cameras, and/or the like.

The memory 620 includes high-speed random-access memory, such as DRAM, SRAM, DDR RAM, or other random-access solid-state memory devices. In some implementations, the memory 620 includes non-volatile memory, such as one or more magnetic disk storage devices, optical disk storage devices, flash memory devices, or other non-volatile solid-state storage devices. The memory 620 optionally includes one or more storage devices remotely located from the one or more processing units 602. The memory 620 comprises a non-transitory computer readable storage medium. In some implementations, the memory 620 or the non-transitory computer readable storage medium of the memory 620 stores the following programs, modules and data structures, or a subset thereof including an optional operating system 630 and an XR presentation module 640.

The operating system 630 includes procedures for handling various basic system services and for performing hardware dependent tasks. In some implementations, the XR presentation module 640 is configured to present XR content to the user via the one or more XR displays 612. To that end, in various implementations, the XR presentation module 640 includes a data obtaining unit 642, a model alignment unit 644, an XR presenting unit 646, and a data transmitting unit 648.

In some implementations, the data obtaining unit 642 is configured to obtain data (e.g., presentation data, interaction data, sensor data, location data, etc.) from at least the controller 110 of FIG. 1. To that end, in various implementations, the data obtaining unit 642 includes instructions and/or logic therefor, and heuristics and metadata therefor.

In some implementations, the model alignment unit 644 is configured to align a model of a virtual environment with a model of a physical environment. To that end, in various implementations, the model alignment unit 644 includes instructions and/or logic therefor, and heuristics and metadata therefor.

In some implementations, the XR presenting unit 646 is configured to display, via the one or more XR displays 612, at least a portion of the virtual environment if the models are aligned. To that end, in various implementations, the XR presenting unit 646 includes instructions and/or logic therefor, and heuristics and metadata therefor.

In some implementations, the data transmitting unit 648 is configured to transmit data (e.g., presentation data, location data, etc.) to at least the controller 110. In some implementations, the data transmitting unit 648 is configured to transmit authentication credentials to the electronic device. To that end, in various implementations, the data transmitting unit 648 includes instructions and/or logic therefor, and heuristics and metadata therefor.

Although the data obtaining unit 642, the model alignment unit 644, the XR presenting unit 646, and the data transmitting unit 648 are shown as residing on a single device (e.g., the electronic device 120), it should be understood that in other implementations, any combination of the data obtaining unit 642, the model alignment unit 644, the XR presenting unit 646, and the data transmitting unit 648 may be located in separate computing devices.

Moreover, FIG. 6 is intended more as a functional description of the various features that could be present in a particular implementation as opposed to a structural schematic of the implementations described herein. As recognized by those of ordinary skill in the art, items shown separately could be combined and some items could be separated. For example, some functional modules shown separately in FIG. 6 could be implemented in a single module and the various functions of single functional blocks could be implemented by one or more functional blocks in various implementations. The actual number of modules and the division of particular functions and how features are allocated among them will vary from one implementation to another and, in some implementations, depends in part on the particular combination of hardware, software, and/or firmware chosen for a particular implementation.

While various aspects of implementations within the scope of the appended claims are described above, it should be apparent that the various features of implementations described above may be embodied in a wide variety of forms and that any specific structure and/or function described above is merely illustrative. Based on the present disclosure one skilled in the art should appreciate that an aspect described herein may be implemented independently of any other aspects and that two or more of these aspects may be combined in various ways. For example, an apparatus may be implemented and/or a method may be practiced using any number of the aspects set forth herein. In addition, such an apparatus may be implemented and/or such a method may be practiced using other structure and/or functionality in addition to or other than one or more of the aspects set forth herein.

It will also be understood that, although the terms “first,” “second,” etc. may be used herein to describe various elements, these elements should not be limited by these terms. These terms are only used to distinguish one element from another. For example, a first node could be termed a second node, and, similarly, a second node could be termed a first node, which changing the meaning of the description, so long as all occurrences of the “first node” are renamed consistently and all occurrences of the “second node” are renamed consistently. The first node and the second node are both nodes, but they are not the same node.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

What is claimed is:

1. A method comprising:
at a device in a physical environment and including a display, non-transitory memory and one or more processors:
obtaining a three-dimensional (3D) model of at least a portion of the physical environment;
obtaining a 3D model of a virtual environment;
determining that a transform applied to the 3D model of the virtual environment aligns the 3D model of the virtual environment within a threshold of the 3D model of at least the portion of the physical environment; and
in response to determining that the transform applied to the 3D model of the virtual model aligns the 3D model of the virtual environment within the threshold of the 3D model of at least the portion of the physical environment:
applying the transform to the 3D model of the virtual environment; and
displaying a portion of the virtual environment based on the transformed 3D model of the virtual environment.

2. The method of claim 1, wherein displaying the portion of the virtual environment includes determining the portion of the virtual environment to be displayed.

3. The method of claim 2, wherein determining the portion of the virtual environment to be displayed includes determining that the portion of the virtual environment is at least a threshold amount different than a corresponding portion of the physical environment.

4. The method of claim 3, wherein determining that the portion of the virtual environment is at least a threshold amount different than the corresponding portion of the physical environment includes comparing a geometry of the portion of the virtual environment and a geometry of the portion of the physical environment.

5. The method of claim 3, wherein determining that the portion of the virtual environment is at least a threshold amount different than the corresponding portion of the physical environment includes comparing a color of the portion of the virtual environment and a color of the portion of the physical environment.

6. The method of claim 2, wherein determining the portion of the virtual environment to be displayed includes determining that the portion of the physical environment to be displayed.

7. The method of claim 6, wherein determining the portion of the physical environment is based on a proximity of the portion of the physical environment.

8. The method of claim 7, further comprising displaying a notification indicating that the proximity.

9. The method of claim 6, wherein determining the portion of the physical environment is based on an object type of the portion of the physical environment.

10. The method of claim 6, further comprising displaying the portion of the physical environment.

11. The method of claim 10, wherein displaying the portion of the physical environment includes displaying the portion of the physical environment at a same location as the portion of the virtual environment.

12. The method of claim 11, further comprising receiving user input indicative of an opacity, wherein displaying the portion of the physical environment at the same location as the portion of the virtual environment includes displaying the portion of the virtual environment with the opacity.

13. The method of claim 10, wherein displaying the virtual environment is based on lighting of the physical environment.

14. The method of claim 10, wherein displaying the portion of the physical environment is based on lighting of the virtual environment.

15. The method of claim 1, wherein displaying the portion of the virtual environment includes displaying one or more concealed objects.

16. The method of claim 1, wherein determining that the transform applied to the 3D model of the virtual environment aligns the 3D model of the virtual environment within the threshold of the 3D model of at least the portion of the physical environment includes determining that an alignment score is greater than a threshold score.

17. The method of claim 1, further comprising, in response to determining that the transform applied to the 3D model of the virtual environment does not align the 3D model of the virtual environment within the threshold of the 3D model of at least the portion of the physical environment, displaying the virtual environment based on the 3D model of the virtual environment.

18. The method of claim 17, further comprising:
while displaying the virtual environment based on the 3D model of the virtual environment, detecting a change in position of the device; and
in response to detecting the change in position, ceasing to display the virtual environment.

19. A device in a physical environment and comprising:
a display;
a non-transitory memory; and
one or more processors to:
obtain a three-dimensional (3D) model of the physical environment;
obtain a 3D model of a virtual environment;
determine that a transform of the 3D model of the virtual environment aligns the 3D model of the virtual environment within a threshold of the 3D model of at least the portion of the physical environment; and
in response to determining that the transform of the 3D model of the virtual environment aligns the 3D model of the virtual environment within the threshold of the 3D model of at least the portion of the physical environment:
apply the transform to the 3D model of the virtual environment; and
display a portion of the virtual environment based on the transformed 3D model of the virtual environment.

20. A non-transitory memory storing one or more programs, which, when executed by one or more processors of a device in a physical environment and including a display, cause the device to:
obtain a three-dimensional (3D) model of the physical environment;
obtain a 3D model of a virtual environment;
determine that a transform of the 3D model of the virtual environment aligns the 3D model of the virtual environment within a threshold of the 3D model of at least the portion of the physical environment; and
in response to determining that the transform of the 3D model of the virtual environment aligns the 3D model of the virtual environment within the threshold of the 3D model of at least the portion of the physical environment:
apply the transform to the 3D model of the virtual environment; and
display a portion of the virtual environment based on the transformed 3D model of the virtual environment.
